(19) United States
(12) Patent Application Publication
(10) Pub. No.: US 2024/0061095 A1
(43) Pub. Date: Feb. 22, 2024

(54) TARGET DETECTION METHOD, TARGET DETECTION DEVICE, AND MILLIMETER WAVE RADAR SYSTEM

(71) Applicant: ALPHA NETWORKS INC., Hsinchu (TW)

(72) Inventors: JIE-DE HUNG, Hsinchu (TW); LIANG-CHI LIN, Hsinchu (TW)

(73) Assignee: ALPHA NETWORKS INC., Hsinchu (TW)

(21) Appl. No.: 18/085,876

(22) Filed: Dec. 21, 2022

(30) Foreign Application Priority Data
Aug. 22, 2022 (TW) 111131543

(51) Int. Cl. G01S 13/536; G01S 13/56; G01S 7/35

(52) U.S. Cl. CPC G01S 13/536; G01S 13/56; G01S 7/356

(57) ABSTRACT

A target detection method includes generate a frequency modulated continuous wave (FMCW) signal; send the FMCW signal through a radar module; receive a first echo signal and a second echo signal reflected by a target and respectively corresponding to a first output signal and a second output signal; process the first echo signal and the second echo signal to correspondingly obtain a first time domain signal S(t1) and a second time domain signal S(t2); process the first time domain signal S(t1) and the second time domain signal S(t2) to obtain a differential time domain signal ΔS(t) which satisfies ΔS(t)=S(t2)-S(t1); convert the differential time domain signal ΔS(t) into an intermediate frequency (IF) signal through Fast Fourier Transform (FFT); calculate a relative distance or a relative velocity of the target relative to the radar module based on the IF signal.

### BACKGROUND OF THE INVENTION

### Technical Field

The present invention relates generally to a detection technology, and more particularly to a detection device and a detection method of a millimeter wave radar.

### Description of Related Art

It is well known that a millimeter wave is an electromagnetic wave and a corresponding frequency range is from 30 GHz to 300 GHz (i.e., a wavelength is from 1 mm to 10 mm), and a millimeter wave radar is a radar operating at the millimeter wave band.

A conventional millimeter radar obtains position information, such as a relative velocity, a relative distance, and a relative angle of a target relative to the radar, etc., by signal processing and calculations, for example Fast Fourier Transform (FFT), based on a frequency modulated continuous wave (FMCW) signal sent by the radar and a signal reflected by the target and received by the radar.

However, as a plate material of the radar would generate many low frequency noises, and the signal reflected by the target would be easily affected by an environment and include many unnecessary noises, the detection ability and the detection stability of the millimeter wave radar to detect a position of the target would be affected. Therefore, how to provide a target detection method which could increase the detection ability and the detection stability to detect the position of the target has become a major issue in the industry.

### BRIEF SUMMARY OF THE INVENTION

In view of the above, the primary objective of the present invention is to provide a target detection method which could increase the detection ability and the detection stability of a millimeter wave radar system to detect a position of a target.

The present invention provides a target detection method including a frequency modulated continuous wave (FMCW) signal including generate a plurality of output signals that is periodic; send the output signals through a radar module, wherein the output signals include a first output signal and a second output signal; receive a first echo signal and a second echo signal reflected by a target and respectively corresponding to the first output signal and the second output signal; process the first echo signal and the second echo signal to correspondingly obtain a first time domain signal S(t1) and a second time domain signal S(t2); process the first time domain signal S(t1) and the second time domain signal S(t2) to obtain a differential time domain signal ΔS(t) which satisfies ΔS(t)=S(t2)-S(t1); convert the differential time domain signal ΔS(t) into an intermediate frequency (IF) signal through Fast Fourier Transform (FFT); and calculate a relative distance or a relative velocity of the target relative to the radar module based on the IF signal.

The present invention further provides a target detection device, wherein a frequency modulated continuous wave (FMCW) signal sent by a radar module is reflected by a target respectively into a first echo signal and a second echo signal. the first echo signal and the second echo signal are processed to correspondingly obtain a first time domain signal S(t1) and a second time domain signal S(t2) that are corresponding. The target detection device is adapted to process the first time domain signal S(t1) and the second time domain signal S(t2) and includes a processor. The target detection device is characterized in that: the processor processes the first time domain signal S(t1) and the second time domain signal S(t2) to obtain a differential time domain signal ΔS(t) which satisfies Δ S(t)=S(t2)-S(t1), and obtains an intermediate frequency (IF) signal from the differential time domain signal ΔS(t) through Fast Fourier Transform (FFT), and calculates a relative distance or a relative velocity of the target relative to the radar module based on the IF signal.

The present invention further provides a millimeter wave radar system adapted to generate a frequency modulated continuous wave (FMCW) signal and to receive a signal reflected by a target. The millimeter wave radar system is characterized in that: the millimeter wave radar system could practice the aforementioned target detection method.

With the aforementioned design, by converting the differential time domain signal ΔS(t), which is obtained from the first time domain signal S(t1) and the second time domain signal S(t2) through differential processing, into the IF signal through FFT, unnecessary noises in the signal reflected by the target could be removed, thereby the IF signal that is more accurate could be obtained, increasing the detection ability and the detection stability to detect the position of the target.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a flowchart of the target detection method according to an embodiment of the present invention;

FIG. 2 is a schematic view showing a relationship between a distance and a strength according to the embodiment and a comparative example of the present invention; and

FIG. 3 is a schematic view showing a relationship between a distance and a strength according to the embodiment and the comparative example of the present invention.

### DETAILED DESCRIPTION OF THE INVENTION

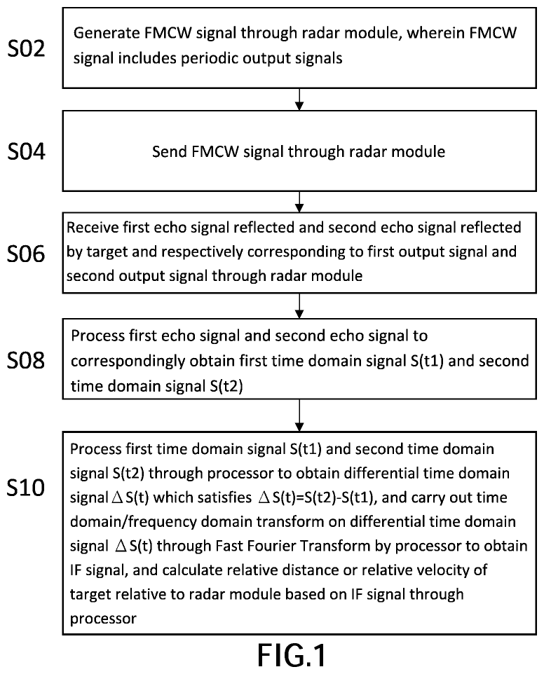

Referring to FIG. 1 which is a flowchart of a target detection method according to an embodiment of the present invention, a millimeter wave radar system could practice the target detection method and includes a radar module and a target detection device.

In the current embodiment, the millimeter wave radar system is mainly adapted to detect a moving object. More specifically, either the target or the radar module moves relative to the other one of the target and the radar module. In practice, the millimeter wave radar system could be applied to a device detecting any moving objects. For example, the millimeter wave radar system could be applied to domestic appliances such as a smart doorbell and a security camera, or in vehicles for blind spot detection, front collision avoidance, or rear collision avoidance.

The radar module could generate and send a frequency modulated continuous wave (FMCW) signal and receive a signal reflected by the target, wherein the FMCW signal includes a plurality of output signals that is periodic. Each of the output signals includes a plurality of scanning frequencies based on time, and the signal reflected by the target includes a plurality of reflecting frequencies respectively corresponding to the scanning frequencies. The target detection device is adapted to detect any moving targets, including a moving human being and a moving vehicle, but not limited thereto. The target detection device includes a processor, which could be a processing chip of an embedded system.

The target detection method includes following steps:

Step S02: the radar module generates an FMCW signal including a plurality of output signals that is periodic, wherein the output signals include a first output signal and a second output signal. In the current embodiment, a period time of each chirp of the FMCW signal is from 10 ms to 20 ms as an example.

Step S04: the radar module sends the FMCW signal.

Step S06: the radar module receives a first echo signal and a second echo signal reflected by a target and respectively corresponding to the first output signal and the second output signal.

Step S08: the first echo signal and the second echo signal are processed to correspondingly obtain a first time domain signal S(t1) and a second time domain signal S(t2). For example, the target detection device processes the FMCW signal respectively with the first echo signal and the second echo signal through frequency mixing, and then two signals obtained via frequency mixing are respectively processed through filtering and Hamming window by the processor of the target detection device, thereby to correspondingly obtain a first time domain signal S(t1) and a second time domain signal S(t2).

Step S10: the processor processes the first time domain signal S(t1) and the second time domain signal S(t2) to obtain a differential time domain signal ΔS(t) which satisfies ΔS(t)=S(t2)-S(t1), and carries out time domain/frequency domain transform on the differential time domain signal ΔS(t) through Fast Fourier Transform (FFT) to obtain an Intermediate Frequency (IF) signal, and calculates a relative distance or a relative velocity of the target relative to the radar module based on the IF signal through the radar range equation.

The output signals include the first output signal and the second output signal that are adjacent, and an output time of the second output signal is later than an output time of the first output signal. In the current embodiment, t₂-t₁=T_{c} (i.e., a time difference between a time t₁ of receiving the first time domain signal S(t1) and a time t2 of receiving the second time domain signal S(t2) is one period time T_{c}). In other embodiments, the time difference between the time t₁ of receiving the first time domain signal S(t1) and the time t₂ of receiving the second time domain signal S(t2) could be, but not limited to, more than one period time T_{c}.

Through the target detection method of the present invention, a farthest detection distance of detecting a target is 30 m and an accuracy of detecting a distance of the target is equal to or greater than 85%.

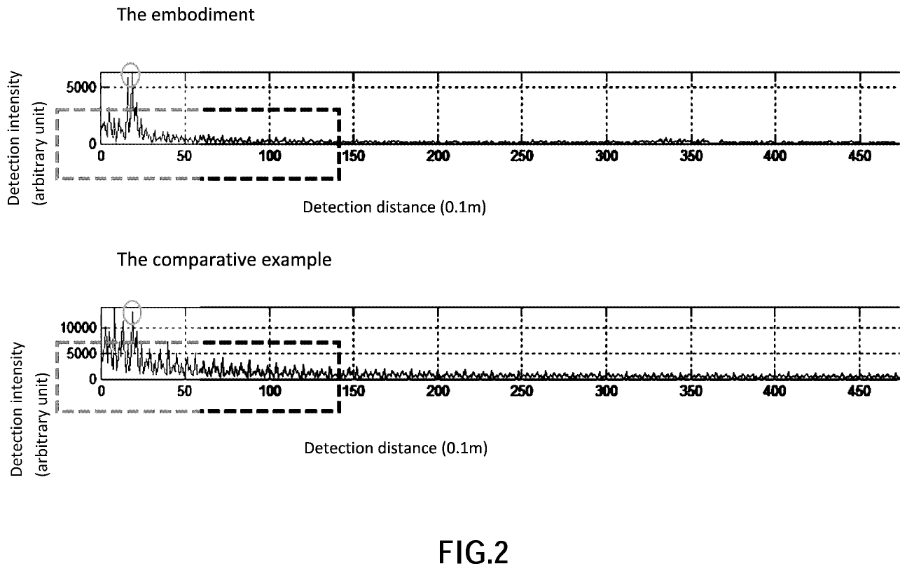

The below description is based on a comparative example and the embodiment of the present invention. In the comparative example, time domain/frequency domain transform is carried out on the first time domain signal S(t1) or the second time domain signal S(t2) directly through FFT to obtain an IF signal. In the current embodiment, the differential time domain signal ΔS(t) obtained from the first time domain signal S(t1) and the second time domain signal S(t2) through differential processing is converted to the IF signal through FFT. Referring to FIG. 2, compared with a performance of low frequency noise below 10 kHz of the comparative example, the embodiment could effectively reduce low frequency noise below 10 kHz by 50%.

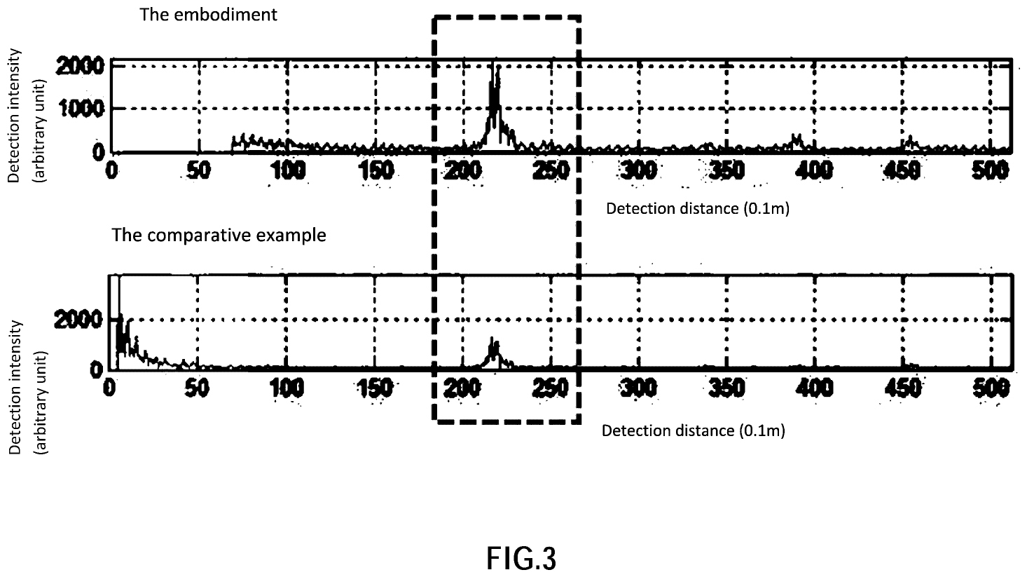

Moreover, referring to FIG. 3, when the target is about 20 m away from the radar module, the IF signal obtained through a method of the comparative example does not only have the worse performance of the low frequency noise but also a worse performance of a signal to noise ratio compared to the IF signal obtained through the method of the embodiment, wherein an efficiency (i.e., increasing the signal to noise ratio of the IF signal) of the IF signal obtained through the method of the embodiment is 25% greater than that of the comparative example.

As shown in Table 1, an accurate distance of the target calculated through the target detection method of the embodiment has a better performance in a detection accuracy on a human being or a vehicle as the target than an accurate distance of the target calculated through the method of the comparative example, wherein a value of each of the detection accuracy is a percentage of times that the target (i.e., the human being or the vehicle) within a particular distance is detected in 20 measurements, and the particular distance for the human being is within 10 m and the particular distance for the vehicle is within 30 m.

TABLE 1

| Detection accuracy | Comparative example | Embodiment |
|---|---|---|
| Human being | 80% | 90% |
| Vehicle | 75% | 85% |

With the aforementioned design, by converting the differential time domain signal ΔS(t), which is obtained from the first time domain signal S(t1) and the second time domain signal S(t2) through differential processing, into the IF signal through FFT, the target detection method of the present invention could remove unnecessary noises in the signal reflected by the target, thereby the IF signal that is more accurate could be obtained, increasing the detection ability and the detection stability to detect a position of the target.

It must be pointed out that the embodiments described above are only some preferred embodiments of the present invention. All equivalent structures and methods which employ the concepts disclosed in this specification and the appended claims should fall within the scope of the present invention.

What is claimed is:

1. A target detection method, comprising:
generating a frequency modulated continuous wave (FMCW) signal comprising a plurality of output signals that is periodic;
sending the FMCW signal through a radar module, wherein the output signals comprise a first output signal and a second output signal;
receiving a first echo signal and a second echo signal reflected by a target and respectively corresponding to the first output signal and the second output signal;
processing the first echo signal and the second echo signal to correspondingly obtain a first time domain signal S(t1) and a second time domain signal S(t2);
processing the first time domain signal S(t1) and the second time domain signal S(t2) to obtain a differential time domain signal ΔS(t) which satisfies ΔS(t)=S(t2)-S(t1);
converting the differential time domain signal ΔS(t) into an intermediate frequency (IF) signal through Fast Fourier Transform (FFT); and
calculating a relative distance or a relative velocity of the target relative to the radar module based on the IF signal.

2. The target detection method as claimed in claim 1, wherein a period time of each chirp of the FMCW signal is from 10 ms to 20 ms.

3. The target detection method as claimed in claim 1, further comprising processing the FMCW signal respectively with the first echo signal and the second echo signal through frequency mixing, and processing two signals obtained via frequency mixing through filtering and Hamming window to correspondingly obtain the first time domain signal S(t1) and the second time domain signal S(t2).

4. The target detection method as claimed in claim 1, wherein a farthest detection distance of detecting the target is 30 m.

5. The target detection method as claimed in claim 4, wherein an accuracy of detecting a distance of the target is equal to or greater than 85%.

6. The target detection method as claimed in claim 1, wherein the radar module generates and sends the FMCW signal, and receives the first echo signal and the second echo signal; either the target or the radar module moves relative to the other one of the target and the radar module.

7. The target detection method as claimed in claim 1, wherein the output signals comprise the first output signal and the second output signal that are adjacent.

8. The target detection method as claimed in claim 1, wherein an output time of the second output signal is later than an output time of the first output signal.

9. A target detection device, wherein a frequency modulated continuous wave (FMCW) signal sent by a radar module is reflected by a target respectively into a first echo signal and a second echo signal; the first echo signal and the second echo signal are processed to correspondingly obtain a first time domain signal S(t1) and a second time domain signal S(t2); the target detection device is adapted to process the first time domain signal S(t1) and the second time domain signal S(t2) and comprises a processor; the target detection device is characterized in that: the processor processes the first time domain signal S(t1) and the second time domain signal S(t2) to obtain a differential time domain signal ΔS(t) which satisfies ΔS(t)=S(t2)-S(t1), and obtains an intermediate frequency (IF) signal from the differential time domain signal ΔS(t) through Fast Fourier Transform (FFT), and calculates a relative distance or a relative velocity of the target relative to the radar module based on the IF signal.

10. A millimeter wave radar system adapted to generate and send a frequency modulated continuous wave (FMCW) signal and to receive a signal reflected by a target is characterized in that: the millimeter wave radar system practices the target detection method as claimed in claim 1.

11. A millimeter wave radar system adapted to generate and send a frequency modulated continuous wave (FMCW) signal and to receive a signal reflected by a target is characterized in that: the millimeter wave radar system practices the target detection method as claimed in claim 2.

12. A millimeter wave radar system adapted to generate and send a frequency modulated continuous wave (FMCW) signal and to receive a signal reflected by a target is characterized in that: the millimeter wave radar system practices the target detection method as claimed in claim 3.

13. A millimeter wave radar system adapted to generate and send a frequency modulated continuous wave (FMCW) signal and to receive a signal reflected by a target is characterized in that: the millimeter wave radar system practices the target detection method as claimed in claim 4.

14. A millimeter wave radar system adapted to generate and send a frequency modulated continuous wave (FMCW) signal and to receive a signal reflected by a target is characterized in that: the millimeter wave radar system practices the target detection method as claimed in claim 5.

15. A millimeter wave radar system adapted to generate and send a frequency modulated continuous wave (FMCW) signal and to receive a signal reflected by a target is characterized in that: the millimeter wave radar system practices the target detection method as claimed in claim 6.

16. A millimeter wave radar system adapted to generate and send a frequency modulated continuous wave (FMCW) signal and to receive a signal reflected by a target is characterized in that: the millimeter wave radar system practices the target detection method as claimed in claim 7.

17. A millimeter wave radar system adapted to generate and send a frequency modulated continuous wave (FMCW) signal and to receive a signal reflected by a target is characterized in that: the millimeter wave radar system practices the target detection method as claimed in claim 8.
